(19) United States
(12) Patent Application Publication
(10) Pub. No.: US 2009/0152344 A1
(43) Pub. Date: Jun. 18, 2009

(54) ELECTRONIC VALUE SAVING APPARATUS, ELECTRONIC VALUE PROCESSING METHOD AND PROGRAM

(75) Inventors: Yasunori KAMADA, Kanagawa (JP); Takayasu KON, Tokyo (JP); Yoichiro SAKO, Tokyo (JP)

Correspondence Address: WOLF GREENFIELD & SACKS, P.C., 600 ATLANTIC AVENUE, BOSTON, MA, 02210-2206, US

(73) Assignee: SONY CORPORATION, Tokyo (JP)

(21) Appl. No.: 12/331,008

(22) Filed: Dec. 9, 2008

(30) Foreign Application Priority Data
Dec. 12, 2007 (JP) 2007-321310

(51) Int. Cl. G06Q 40/00; G07F 19/00

(52) U.S. Cl. 235/379

(57) ABSTRACT

An electronic value saving apparatus is provided that communicates with an information processing apparatus capable of storing electronic value and includes a storage section storing one or more electronic values relating to a predetermined service, a first communicating section communicating with the information processing apparatus and transmitting/receiving the electronic value to/from the information processing apparatus, a process type judging section judging a type of process defining the transmission/reception of the electronic value, a state judging section judging whether execution of process is possible for each type of the process based on the judgment result of the process type judging section, and a data processing section processing the electronic value received from the information processing apparatus or the electronic value to be transmitted to the information processing apparatus based on the judgment result of the process type judging section and the judgment result of the state judging section.

### CROSS REFERENCES TO RELATED APPLICATIONS

The present invention contains subject matter related to Japanese Patent Application JP 2007-321310 filed in the Japan Patent Office on Dec. 12, 2007, the entire contents of which being incorporated herein by reference.

### BACKGROUND OF THE INVENTION

1. Field of the Invention

The present invention relates to an electronic value saving apparatus, an electronic value processing method and a program.

2. Description of the Related Art

In recent years, an information processing apparatus, such as a non-contact type IC (Integrated Circuit) card or a mobile phone with a non-contact type IC chip, capable of communicating in a non-contact manner with a reader/writer (or a device having a read/write function) has become widespread.

The information processing apparatus as described above capable of communicating in a non-contact manner with a reader/writer can, by including a tamper-resistant IC chip, safely perform transmission/reception or update of data such as electronic money whose tampering may become a problem. Accordingly, provision of a variety of services using the information processing apparatus as described above with a non-contact type IC chip capable of communicating with a reader/writer is becoming widespread. Also, with the spread of the provision of the services, the information processing apparatus such as the mobile phone with a non-contact type IC chip is becoming more widespread.

Further, the information processing apparatus including an IC chip is not limited to that communicating with a reader/writer in a non-contact manner, and the information processing apparatus that communicates with a reader/writer in a contact manner is also widespread. By communicating in a contact manner, communication can be performed more securely, and thus, it is applied to a cash card, a credit card and the like requiring a highly secure communication.

Under such circumstance, various technologies relating to the use of electronic money are being developed. As a technology that allows a user, who uses an installment payment plan using electronic money, to decide the installment amount at the time of each payment, there is JP-A-2000-306162, for example. As a technology of, when making settlement using electronic money, loading electronic money onto an IC card when the balance of electronic money stored in the IC card is smaller than a purchase amount, there is JP-A-2002-366862, for example.

### SUMMARY OF THE INVENTION

As the information processing apparatus with an IC chip communicating in a contact/non-contact manner becomes widespread, it is becoming more common for users to possess a plurality of the information processing apparatuses relating to similar or dissimilar services. Here, with an IC card in which electronic money is stored as an example, in a case where a user possesses a plurality of the IC cards in which electronic money is stored, it is necessary to individually load electronic money onto each of the IC cards. However, once loaded, the amount of electronic money cannot be transferred even between the IC cards relating to a similar service, and thus, the user can only separately use the electronic money loaded onto each of the IC cards. Thus, the related technology using electronic money aims to attain a way of making settlement using electronic value stored in a single IC card.

Further, the related technology relating to the use of electronic money is a technology for making settlement. Accordingly, even when using the related technology relating to the use of electronic money, electronic values, such as electronic money or points for a specific service, respectively stored in a plurality of the information processing apparatuses (for example, IC cards or mobile phones) cannot be managed in an integrated manner. Here, the electronic value is digitized information having economic value.

Further, as the information processing apparatuses capable of storing the electronic value, an IC card, a mobile phone and the like, for example, are widespread. However, the information processing apparatus of the related art is for being carried by users and for using the electronic value stored therein. More specifically, the information processing apparatus of the related art is designed to be compact so that users can carry the apparatus with ease, and since it is easily carried around, it is also becoming easy for the users to, for example, use the electronic value by holding the information processing apparatus of the related art over a reader/writer in a store.

Here, with physical money, for example, there is a savings box with which one's main aim is to accumulate money. However, the information processing apparatus of the related art is to be carried by users and for using the electronic value stored therein as described above, and it does not serve as what can be referred to as a savings box for electronic value with which one's main aim is to accumulate electronic value.

In view of the foregoing, it is desirable to provide a new and improved electronic value saving apparatus, an electronic value processing method and a program enabling collective management of electronic value stored in an information processing apparatus capable of storing the electronic value and accumulation of the electronic value.

According to an embodiment of the present invention, there is provided an electronic value saving apparatus that communicates in a contact/non-contact manner with an information processing apparatus capable of storing electronic value, including a storage section storing one or more electronic values relating to a predetermined service, a first communicating section communicating with the information processing apparatus and transmitting/receiving the electronic value to/from the information processing apparatus, a process type judging section judging a type of process defining the transmission/reception of the electronic value, a state judging section judging whether execution of process is possible for each type of process based on the judgment result of the process type judging section, and a data processing section processing the electronic value received from the information processing apparatus or the electronic value to be transmitted to the information processing apparatus based on the judgment result of the process type judging section and the judgment result of the state judging section.

With such configuration, the electronic value stored in the information processing apparatus capable of storing the electronic value can be managed in an integrated manner, and the electronic value can be accumulated.

Further, the storage section may further store state information specifying whether execution of process is possible, and the state judging section may judge whether execution of process is possible based on the judgment result of the process type judging section and the state information.

With such configuration, a function similar to that of a savings box accumulating physical money, where electronic value is easy to put away but is difficult to draw out, can be realized.

Further, the state information may specify whether execution of process of transmitting the electronic value to the information processing apparatus is possible, and the state judging section may judge, when the judgment result of the process type judging section indicates the process of transmitting the electronic value to the information processing apparatus, whether execution of process is possible in accordance with the state information, and judge, when the judgment result of the process type judging section indicates the process of receiving the electronic value from the information processing apparatus, that the process can be executed.

With such configuration, a function similar to that of a savings box accumulating physical money, where electronic value is easy to put away but is difficult to draw out, can be realized.

Further, the storage section stores user information including setup information for user, and the electronic value saving apparatus may further include a user identifying section identifying a user based on a user operation and the user information, wherein the state judging section may judge whether execution of process is possible for each user identified by the user identifying section.

With such configuration, an apparatus, which is physically one body, can be used as if it is multiple savings boxes.

Further, the electronic value saving apparatus may further include an electronic value managing section managing for each user based on the user information, the electronic value stored in the storage section, wherein the data processing section may process the electronic value for the user identified by the user identifying section among the electronic values being managed for respective users in the storage section.

With such configuration, an apparatus, which is physically one body, can be used as if it is multiple savings boxes.

Further, the storage section may further store goal data including goal value for the electronic value to be stored or goal data including the goal value and goal deadline specifying deadline for achieving the goal, and the electronic value saving apparatus may further include a goal achievement judging section judging whether the goal is achieved or not based on the goal data and the electronic value that is stored in the storage section.

With such configuration, a user can be given the joy of accumulating the electronic value.

Further, the electronic value saving apparatus may further include a state setting section setting, in the storage section, state information specifying whether execution of process is possible based on the judgment result of the goal achievement judging section.

With such configuration, a function similar to that of a savings box accumulating physical money, where electronic value is easy to put away but is difficult to draw out, can be realized.

Further, the state setting section may set the state information stored in the storage section to a state where execution of process is possible in response to a predetermined user operation even when the goal achievement judging section judges that the goal is not achieved.

With such configuration, a function similar to that of a savings box accumulating physical money, where electronic value is easy to put away but is difficult to draw out, can be realized.

Further, the electronic value saving apparatus may further include a notifying section notifying a user, wherein the goal achievement judging section may make the notifying section notify the state of the electronic value stored in the storage section in relation to the goal value.

With such configuration, the accumulation state of the accumulated electronic value can be notified to a user. Further, with such configuration, the user can be given the joy of accumulating the electronic value.

Further, the goal achievement judging section may make the notifying section notify at least one or more of the pieces of information that the electronic value stored in the storage section reached the goal, information that gap between the electronic value stored in the storage section and the goal value is within a predetermined range and comparative information of the electronic value stored in the storage section to the goal value.

With such configuration, the accumulation state of the accumulated electronic value can be notified to a user. Further, with such configuration, the user can be given the joy of accumulating the electronic value.

Further, the electronic value saving apparatus may further include an operation section setting the goal value and/or the goal deadline in the goal data.

With such configuration, a user can be given the joy of accumulating the electronic value.

Further, the data processing section may add the electronic value transmitted from the information processing apparatus to the electronic value that corresponds to the electronic value transmitted from the information processing apparatus among the electronic values stored in the storage section, and have a command to subtract the amount that corresponds to the added amount from the electronic value stored in the information processing apparatus transmitted to the information processing apparatus.

With such configuration, the sum of the electronic values before the accumulation process and the sum of the electronic values after the accumulation process can be maintained the same.

Further, the data processing section may subtract from the electronic value that corresponds to the electronic value transmitted to the information processing apparatus, among the electronic values stored in the storage section, the amount corresponding to the amount transmitted to the information processing apparatus.

With such configuration, the sum of the electronic values before the withdrawal process and the sum of the electronic values after the withdrawal process can be maintained the same.

Further, the data processing section may store, in the storage section, a log corresponding to the processing on the electronic value.

With such configuration, the records of “when”, “which user”, “accumulated/withdrew how much”, “for which electronic value” can be preserved.

The electronic value saving apparatus may further include a second communicating section communicating with an external apparatus storing the electronic value via a network, wherein the data processing section may process the electronic value the second communicating section received.

With such configuration, the electronic value saving apparatus can communicate with an external apparatus, and execute the accumulation process or the withdrawal process for the electronic value with the external apparatus. Further, with such configuration, by cooperating with the external apparatus, the value amount of the electronic value stored in the storage section can be exchanged with that of the electronic value managed by the external apparatus.

According to another embodiment of the present invention, there is provided an electronic value processing method of an electronic value saving apparatus that includes a storage section storing one or more electronic values relating to a predetermined service and a communicating section, and communicates in a contact/non-contact manner with an information processing apparatus capable of storing electronic value, including the steps of judging a type of process defining the transmission/reception of the electronic value, judging whether execution of process is possible for each type of process based on the judgment result of the step of judging a type of process, and processing the electronic value received from the information processing apparatus or the electronic value to be transmitted to the information processing apparatus based on the judgment result of the step of judging a type of process and the judgment result of the step of judging whether execution of process is possible.

By using such method, the electronic value stored in the information processing apparatus capable of storing the electronic value can be managed in an integrated manner, and the electronic value can be accumulated.

According to another embodiment of the present invention, there is provided a program, which can be used in an electronic value saving apparatus that includes a storage section storing one or more electronic values relating to a predetermined service and a communicating section, and communicates in a contact/non-contact manner with an information processing apparatus capable of storing the electronic value, making a computer perform the steps of judging a type of process defining the transmission/reception of the electronic value, judging whether execution of process is possible for each type of process based on the judgment result of the step of judging a type of process, and processing the electronic value received from the information processing apparatus or the electronic value to be transmitted to the information processing apparatus based on the judgment result of the step of judging a type of process and the judgment result of the step of judging whether execution of process is possible.

With such program, the electronic value stored in the information processing apparatus capable of storing the electronic value can be managed in an integrated manner, and the electronic value can be accumulated.

According to the embodiments of the present invention described above, electronic values stored in an information processing apparatus capable of storing electronic value can be managed in an integrated manner, and the electronic value can be accumulated.

### BRIEF DESCRIPTION OF THE DRAWINGS

FIG. 1 is an explanatory diagram showing an example of the appearance of an electronic value saving apparatus according to an embodiment of the present invention.

FIG. 2 is a block diagram showing the electronic value saving apparatus according to the embodiment of the present invention.

FIG. 3 is an explanatory diagram showing an example of a hardware configuration of the electronic value saving apparatus according to the embodiment of the present invention.

FIGS. 4A and 4B are explanatory diagrams showing a first method of managing electronic value by the electronic value saving apparatus according to the embodiment of the present invention.

FIGS. 5A and 5B are explanatory diagrams showing a second method of managing electronic value by the electronic value saving apparatus according to the embodiment of the present invention.

FIGS. 6A and 6B are explanatory diagrams showing a third method of managing electronic value by the electronic value saving apparatus according to the embodiment of the present invention.

FIG. 7 is an explanatory diagram showing an example of communication between an external apparatus and the electronic value saving apparatus according to the embodiment of the present invention.

FIG. 8 is a flow chart showing an example of a method of processing electronic value according to the embodiment of the present invention.

FIG. 9 is a flow chart showing an example of a process of setting a goal according to the embodiment of the present invention.

FIG. 10 is a flow chart showing an example of a process of releasing non-executable state according to the embodiment of the present invention.

FIG. 11 is a flow chart showing an example of a process of accumulating electronic value of the embodiment of the present invention.

FIG. 12 is a flow chart showing an example of a process of withdrawing electronic value according to the embodiment of the present invention.

FIG. 13 is a flow chart showing an example of a process of confirming the achievement of a goal according to the embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### Electronic Value Saving Apparatus According to the Embodiment of the Present Invention

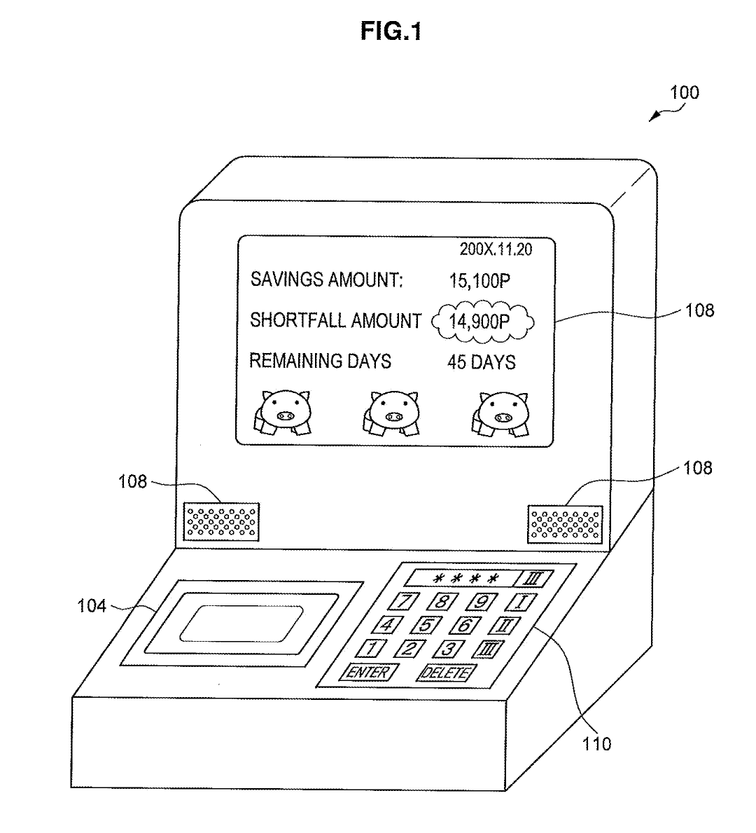

First, an example of the appearance of an electronic value saving apparatus according to an embodiment of the present invention will be shown. FIG. 1 is an explanatory diagram showing an example of the appearance of an electronic value saving apparatus 100 according to the embodiment of the present invention. Incidentally, in the following, the electronic value saving apparatus 100 that communicates with an IC card or a mobile phone with an IC chip (hereinafter, collectively referred to as “information processing apparatus”) in a non-contact manner, for example, will be described as the electronic value saving apparatus according to the embodiment of the present invention. However, the electronic value saving apparatus according to the embodiment of the present invention is not limited to such. For example, the electronic value saving apparatus according to the embodiment of the present invention can be configured to communicate with the IC card or the mobile phone with an IC chip in a contact manner, for example.

Referring to FIG. 1, the electronic value saving apparatus 100 includes, for example, a communication port (first communicating section 104), an operation panel (operation section 110), a display panel (notifying section 108), a speaker (notifying section 108) and the like.

For example, the communication port (first communicating section 104) communicates with the information processing apparatus when a user holds the information processing apparatus over the communication port, and performs transmission/reception of electronic value relating to accumulation (transfer of electronic value from the information processing apparatus to the electronic value saving apparatus 100)/withdrawal (transfer of electronic value from the electronic value saving apparatus 100 to the information processing apparatus) of the electronic value. The operation panel (operation section 110) enables a user operation, and lets the user determine a process to be executed by the information processing apparatus such as accumulation or withdrawal of the electronic value, input a password, set a goal for the accumulation, and the like. The display panel (notifying section 108) visually conveys information to the user. For example, in FIG. 1, an example is shown where amount of the electronic value accumulated in the electronic value saving apparatus 100 (savings amount), shortfall amount to the amount of the goal electronic value (goal amount), and information on the number of remaining days for achieving the goal are displayed. The speaker (notifying section 108) aurally conveys information to the user. Information to be conveyed from the speaker (notifying section 108) includes audio information indicating whether the set goal is achieved or not, sound indicating that various processes such as accumulation and withdrawal of the electronic value are completed, and the like.

By having the configuration as described above, the electronic value saving apparatus 100 enables the user to accumulate the electronic value or to withdraw the accumulated electronic value. Further, by enabling goal setting by the user or notification of information to the user, the electronic value saving apparatus 100 gives the user the joy of saving. Note that FIG. 1 only shows an example of the electronic value saving apparatus according to the embodiment of the present invention, and the appearance, shape, relative size to the information processing apparatus and the like are not limited to those shown in FIG. 1. Hereunder, the electronic value saving apparatus 100 will be described in more detail.

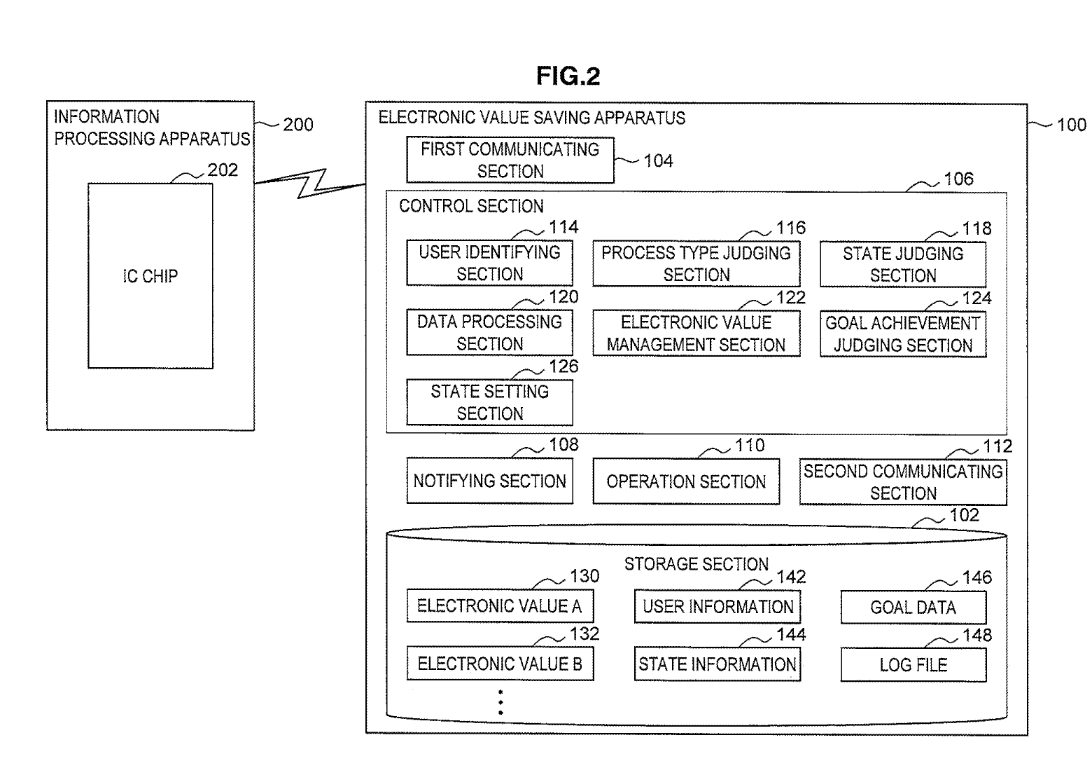

FIG. 2 is a block diagram showing the electronic value saving apparatus 100 according to the embodiment of the present invention. Incidentally, an information processing apparatus 200 with an IC chip 202 storing the electronic value and capable of communicating with the electronic value saving apparatus 100 in a non-contact manner is also shown in FIG. 2.

[Information Processing Apparatus 200]

First, the information processing apparatus 200 according to the embodiment of the present invention will be described. The IC chip 202 included in the information processing apparatus 200 is a chip on which various parts relating to the communication with a reader/writer or the electronic value saving apparatus 100 are integrated, and can be tamper-resistant. Incidentally, FIG. 2 shows a configuration where the information processing apparatus 200 includes only the IC chip 202. However, it is not limited to such, and a control section (not shown) controlling the entire information processing apparatus 200, a storage section (not shown) storing various applications, data and the like, a communicating section (not shown) outside the IC chip communicating with an external apparatus such as a base station, and the like, for example, can be included.

The IC chip 202 includes, for example, an antenna circuit for wireless communication (not shown), a Micro Processing Unit (MPU; not shown), a non-volatile memory (not shown) and the like.

The antenna circuit for wireless communication includes, for example, a resonant circuit having a coil as a transmitting/receiving antenna with a predetermined inductance and a capacitor with a predetermined capacitance and a demodulator circuit, and receives a magnetic field of 13.56 MHz (hereinafter, referred to as a “carrier”) transmitted from a reader/writer or the electronic value saving apparatus 100, and demodulates various commands or data (for example, electronic value). Here, the IC chip 202 can have the transmitting/receiving antenna embedded therein, or the transmitting/receiving antenna and the IC chip can be included as one package. However, it is not limited to such, and the transmitting/receiving antenna and the IC chip can be included as separate bodies.

Further, the antenna circuit for wireless communication includes a load modulation circuit and performs load modulation, for example, and communicates with the reader/writer or the electronic value saving apparatus 100 over a carrier by changing the impedance of the information processing apparatus to the reader/writer or the electronic value saving apparatus 100. More particularly, the reader/writer or the electronic value saving apparatus 100 communicates with the information processing apparatus by transmitting a carrier signal to the information processing apparatus and detecting the change in the impedance of the information processing apparatus to the reader/writer or the electronic value saving apparatus 100 generated by the load modulation as a response signal from the information processing apparatus.

The MPU performs processes according to the various commands demodulated by the antenna circuit for wireless communication. The non-volatile memory functions as an internal memory of the IC chip 202 and can store data such as the electronic value.

With the configuration as described above, the information processing apparatus 200 can store electronic value, process various data, and communicate with the reader/writer or the electronic value saving apparatus 100 over a carrier.

[Electronic Value Saving Apparatus 100]

Next, the electronic value saving apparatus 100 according to the embodiment of the present invention will be described. Referring to FIG. 2, the electronic value saving apparatus 100 includes a storage section 102, the first communicating section 104, a control section 106, the notifying section 108, the operation section 110 and a second communicating section 112.

Further, the electronic value saving apparatus 100 may include a Read Only Memory (ROM; not shown) storing programs to be used by the control section 106 and data for control such as computational parameters, a Random Access Memory (RAM; not shown) temporarily storing programs and the like to be executed by the control section 106. The electronic value saving apparatus 100 can connect the components with each other via a bus serving as a transmission path for data, for example.

[Example of Hardware Configuration of Electronic Value Saving Apparatus 100]

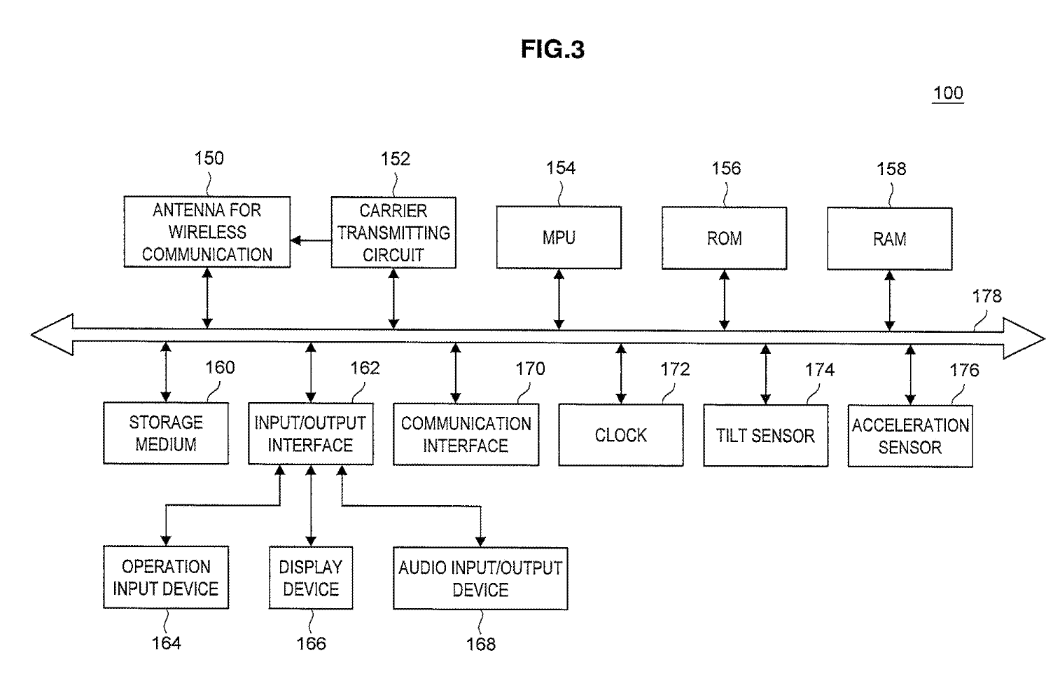

FIG. 3 is an explanatory diagram showing an example of a hardware configuration of the electronic value saving apparatus 100 according to the embodiment of the present invention. Referring to FIG. 3, the electronic value saving apparatus 100 includes an antenna for wireless communication 150, a carrier transmitting circuit 152, an MPU 154, a ROM 156, a RAM 158, a storage medium 160, an input/output interface 162, an operation input device 164, a display device 166, an audio input/output device 168, a communication interface 170, a clock 172, a tilt sensor 174 and an acceleration sensor 176. Further, the electronic value saving apparatus 100 can connect each component with a bus 178 serving as a transmission path for data, for example. Here, in FIG. 3, for example, the antenna for wireless communication 150 and the carrier transmitting circuit 152 correspond to the first communicating section 104 in FIG. 2, the MPU 154 corresponds to the control section 106 in FIG. 2, the storage medium 160 corresponds to the storage section 102 in FIG. 2, the operation device 164 corresponds to the operation section 110 in FIG. 2, the display device 166 and the audio input/output device 168 correspond to the notifying section 108 in FIG. 2, and the communication interface 170 correspond to the second communicating section 112, respectively.

The antenna for wireless communication 150 is configured by, for example, a resonant circuit with a predetermined frequency (for example, 13.56 MHz) having a coil with a predetermined inductance and a capacitor with a predetermined capacitance.

The carrier transmitting circuit 152 includes, for example, a modulation circuit performing amplitude shift keying (ASK) modulation and an amplifier circuit amplifying the output of the modulation circuit, and transmits a carrier carrying a carrier signal from the antenna for wireless communication 150. Here, for example, the transmission of the carrier by the carrier transmitting circuit 152 is controlled by the MPU 154. Thus, the electronic value saving apparatus 100 can efficiently communicate with the information processing apparatus 200.

The MPU 154 functions as the control section 106 described later. The ROM 156 stores programs to be used by the MPU 154 and data for control such as computational parameters, and the RAM 158 temporarily stores programs and the like to be executed by the MPU 154.

The storage medium 160 functions as the storage section 102 of the electronic value saving apparatus 100, and, for example, stores electronic value, applications to be used by the electronic value saving apparatus 100, various data (described later) and the like.

The input/output interface 162 connects, for example, the operation input device 164, the display device 166 and the audio input/output device 168 with the bus 178. Here, the input/output interface 162 may be, for example, a universal serial bus (USB) terminal, a digital visual interface (DVI) terminal, a high-definition multimedia interface (HDMI) terminal, but it is not limited to such.

The operation input device 164 is, for example, provided on the electronic value saving apparatus 100 and is connected, within the electronic value saving apparatus 100, to the input/output interface 162. The operation input device 164 may be, for example, buttons, direction keys, or a rotary selector such as a jog dial, or a combination thereof, but it is not limited to such. The display device 166 is, for example, provided on the electronic value saving apparatus 100 and is connected, within the electronic value saving apparatus 100, to the input/output interface 162. The display device 166 may be, for example, a liquid crystal display (LCD) or an organic ElectroLuminescence display (organic EL display; also called an organic light emitting diode (OLED) display), but it is not limited to such. The audio input/output device 168 is configured by, for example, a device such as a microphone or a speaker that inputs or outputs audio, and is connected, within the electronic value saving apparatus 100, to the input/output interface 162. Incidentally, it is needless to say that the input/output interface 162 can be connected to an operation input device (for example, a keyboard or a mouse), a display device (for example, an external display) or an audio input/output device (for example, an external speaker or an external microphone) serving as an external device of the electronic value saving apparatus 100.

The communication interface 170 is an interface for communicating with an external apparatus and can function as the second communicating section 112. Here, the electronic value saving apparatus 100 and the external apparatus can be connected to each other physically via a universal serial bus (USB) terminal, a terminal of IEEE 1394 Standard or the like, or they may be connected to each other wirelessly by using a wireless universal serial bus (WUSB), an IEEE 802.11 or the like, for example. Further, the electronic value saving apparatus 100 and the external apparatus may be connected to each other via a network, for example. Here, the network may be a wired network such as a local area network (LAN) or a wide area network (WAN), a wireless network such as wireless local area network (WLAN) using Multiple-Input Multiple-Output (MIMO), the Internet using communication protocol such as Transmission Control Protocol/Internet Protocol (TCP/IP), or the like, but it is not limited to such. Thus, the communication interface 170 can be an interface in accordance with the form of connection to the external apparatus.

The clock 172 creates time information specifying date, time and the like. The time information created by the clock 172 is used for calculating the remaining days (remaining days until the set date for achieving the goal) shown in FIG. 1, for example. Here, the clock 172 may be, for example, a mechanical clock or a quartz clock, but it is not limited to such.

The tilt sensor 174 detects the tilt of the electronic value saving apparatus 100, and the acceleration sensor 176 detects the acceleration of the electronic value saving apparatus 100. By including the tilt sensor 174 and the acceleration sensor 176, the electronic value saving apparatus 100 can detect the change in the motion of the electronic value saving apparatus 100 and obtain information regarding the change in the motion. Here, the electronic value saving apparatus 100 can, for example, change the contents of state information (described later) specifying whether execution of various processes such as accumulation and withdrawal is possible according to the obtained information regarding the motion. Incidentally, by making the acceleration sensor 176 a 3-axis acceleration sensor, for example, the electronic value saving apparatus according to the present invention can also have the acceleration sensor and the tilt sensor in one package.

With the hardware configuration as shown in FIG. 3, the electronic value saving apparatus 100 can communicate with the information processing apparatus 200 and exchange electronic value with the information processing apparatus 200. Further, the electronic value saving apparatus 100 can store the electronic value received from the information processing apparatus 200 (corresponds to the accumulation of the electronic value), and thus, it has a function of accumulating electronic value and a function of transmitting stored electronic value to the information processing apparatus 200 (corresponds to the withdrawal of the electronic value). Accordingly, the electronic value saving apparatus 100 can serve as a savings box for electronic value.

Referring again to FIG. 2, each component of the electronic value saving apparatus 100 will be described. The storage section 102 is a storage means provided in the electronic value saving apparatus 100, and can store various data such as electronic value, user information, state information, goal data, log file and the like, for example.

Here, the electronic value is digitized information having economic value such as electronic money, point, coupon data and the like. Incidentally, in the following, description will be made for the electronic value that can be handled quantitatively such as electronic money or point, but the electronic value is not limited to such. The electronic value saving apparatus according to the embodiment of the present invention can store electronic value that is not handled quantitatively such as coupon data and transmit the same to the information processing apparatus 200, for example.

The user information is data including setup information for user using the electronic value saving apparatus 100, and the user information is used, for example, to identify the user using the electronic value saving apparatus 100 or to identify the electronic value to be processed. Here, the user information may be information relating to a password or information relating to a memory area (for example, a folder name or an address) in the storage section 102 assigned to the user, but it is not limited to such.

The state information is information specifying whether execution of various processes such as accumulation process (process of transferring electronic value from the information processing apparatus 200 to the electronic value saving apparatus 100) and withdrawal process (process of transferring electronic value from the electronic value saving apparatus 100 to the information processing apparatus 200) are possible for each of the processes. Here, the state information may be set for every process by the electronic value saving apparatus 100 or it may be set only for a specific process. Here, in a case there is a process for which the state information is not set, the electronic value saving apparatus 100 can regard the case as a case where the state information enabling execution of process is set. Accordingly, for example, when the state information is set only for the withdrawal process, the electronic value saving apparatus 100 can execute the accumulation process arbitrarily and restrict the withdrawal process according to the state information.

As described above, by restricting execution of a specific process (for example, withdrawal process) based on stored state information, the electronic value saving apparatus 100 can realize a function similar to that of a savings box accumulating physical money, where electronic value is easy to put away but is difficult to draw out.

Incidentally, the state information can be individual information for each of the users specified in the user information. When the state information is set for each user, it also becomes possible to restrict execution of a specific process (for example, withdrawal process) for an identified user.

The goal data is data including goal value (goal amount) for the electronic value to be accumulated, a deadline for achieving the goal, and the like. Here, a goal included in the goal data is not limited to an ultimate goal, but can be short-term goal for every day in the course of achieving the ultimate goal, for example.

Further, the goal data can be set by the control section 106 by a user operating the operation section 110, for example. Incidentally, the goal data can be set individually for each user specified in the user information.

The result of a process by the control section 106, for example, is recorded in the log file. By recording a log, it becomes possible to preserve the records of “when”, “which user”, “accumulated/withdrew how much”, “for which electronic value”, for example.

The storage section 102 can store various data as described above. Here, in FIG. 2, an example is shown where electronic value A 130, electronic value B 132, . . . , user information 142, state information 144, goal data 146, and log file 148 are stored in the storage section 102. Incidentally, the electronic value, the user information, the state information, the goal data, the log file and the like need not be stored in an integrated manner in the storage section 102. For example, if the electronic value saving apparatus 100 includes another storage means, the electronic value saving apparatus 100 can store the electronic value, the user information, the state information, the goal data, the log file and the like in a distributed manner.

Here, the storage section 102 may be, for example, a magnetic recording medium, such as a hard disk, or a non-volatile memory such as an Electronically Erasable and Programmable Read Only Memory (EEPROM), a flash memory, a Magnetoresistive Random Access Memory (MRAM), a Ferroelectric Random Access Memory (FeRAM) or a Phase change Random Access Memory (PRAM), but it is not limited to such.

The first communicating section 104 includes, for example, the antenna for wireless communication 150 and the carrier transmitting circuit 152 shown in FIG. 3, and has a function of communicating with the information processing apparatus 200.

The control section 106 is configured by an MPU or the like, for example, and controls the entire electronic value saving apparatus 100. Further, the control section 106 includes a user identifying section 114, a process type judging section 116, a state judging section 118, a data processing section 120, an electronic value managing section 122, a goal achievement judging section 124 and a state setting section 126. Note that the control section 106 can also include a goal data creating section (not shown) that newly creates or updates the goal data in response to a user input from the operation section 110, for example.

The user identifying section 114 identifies a user based on a user operation on the operation section 110 (for example, inputting of password) and the user information, for example. Further, the user identifying section 114 can also newly create or change the user information.

The process type judging section 116 judges a type of process defining transmission/reception of electronic value. Here, the type of process to be executed may be accumulation process relating to reception of the electronic value, withdrawal process relating to transmission of the electronic value or the like, but it is not limited to such. Further, the process type judging section 116 can judge a type of process to be executed based on an input signal transferred from the operation section 110, for example.

The state judging section 118 judges whether execution of process is possible for each type of processes based on the type of process judged by the process type judging section 116. Here, for example, by using the state information stored in the storage section 102, the state judging section 118 can judge whether execution of a process corresponding to the type of process judged by the process type judging section 116 is allowed or not.

Further, by using the state information for the user identified by the user identifying section 114, the state judging section 118 can perform the judgment for each user. That is, when the state information is set for each user, the state judging section 118 can judge, for each user, whether execution of a process corresponding to the type of process judged by the process type judging section 116 is allowed or not based on the state information set for each user. Accordingly, in the above-described case, the electronic value saving apparatus 100 can restrict the execution of processes for each user. Note that, when the state information stored in the storage section 102 is common to all users, each of the users will be treated equally by the electronic value saving apparatus 100.

When it is judged by the state judging section 118 that the execution of a process is allowed, the data processing section 120 executes the process corresponding to the type of process judged by the process type judging section 116 on the electronic value received by the first communicating section 104 (electronic value transmitted from the information processing apparatus 200) or the electronic value stored in the storage section 102. Further, the data processing section 120 can record a log in accordance with the executed process in the log file 148 of the storage section 102. Incidentally, the flow of each process by the electronic value saving apparatus 100 will be described later.

Further, the data processing section 120 updates, according to the process result, the amount (hereinafter, referred to as “value amount”) indicating the economic value of the electronic value stored in the storage section 102.

Further, when electronic value is input from an external apparatus via the second communicating section 112 described later (which case will be described later), the data processing section 120 can store the electronic value or the value amount of the electronic value in the storage section 102.

(Electronic Value Management Method)

Here, a method for managing electronic value by the electronic value saving apparatus 100 will be described. The management of electronic value by the electronic value saving apparatus 100 can be performed by the data processing section 120 of the control section 106 (in the following, it is assumed that it is performed by the control section 106). Incidentally, in the following, electronic value, such as electronic value or points, whose value amount is expressed numerically will be described as an example of the electronic value, but it is needless to say that the electronic value according to the embodiment of the present invention is not limited to such whose value amount is expressed numerically. Further, in the following, a case of writing, in the storage section 102, the electronic value stored in the IC chip 202 of the information processing apparatus 200, that is, a case of accumulating the electronic value will be described as an example.

(I) First Management Method

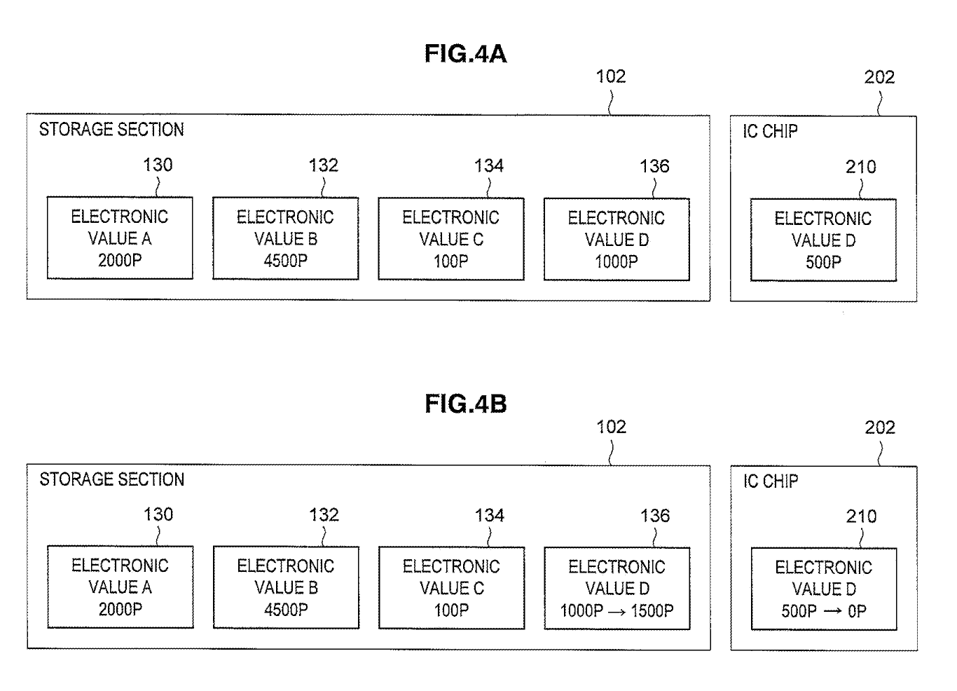

FIGS. 4A and 4B are explanatory diagrams showing a first method of managing electronic value by the electronic value saving apparatus 100 according to the embodiment of the present invention. Here, FIG. 4A shows a state before the electronic value stored in the information processing apparatus 200 is written in the storage section 102, and FIG. 4B shows a state after the electronic value stored in the information processing apparatus 200 is written in the storage section 102.

Referring to FIG. 4A, electronic value A 130 corresponding to service A, electronic value B 132 corresponding to service B, electronic value C 134 corresponding to service C, and electronic value D 136 corresponding to service D are stored in the storage section 102. Further, electronic value D 210 corresponding to service D is stored in the IC chip of the information processing apparatus 200.

The control section 106 reads out the electronic value D 210 stored in the information processing apparatus 200 and judges whether there is electronic value of a service corresponding to the electronic value that is read out in the storage section 102. Here, the reading out of the electronic value from the information processing apparatus 200 can be performed by transmitting a read-out command from the first communicating section 104 over a carrier and receiving the electronic value transmitted from the information processing apparatus 200 in response to the read-out command.

In FIG. 4A, since electronic value D 136 corresponding to service D is stored in the storage section 102, the control section 106 writes the value amount of electronic value D 210 in electronic value D 136. More specifically, the control section 106 transfers the value amount “500 P” of electronic value D 210 stored in the information processing apparatus 200 to electronic value D 136 stored in the stored in the storage section 102. Here, the transfer of electronic value means adding the value amount of the electronic value of the transfer source to the value amount of the electronic value of the transfer destination and subtracting the amount equivalent to the added amount from the value amount of the electronic value of the transfer source.

Here, after adding the value amount to electronic value D 136 stored in the storage section 102, the control section 106 transmits a command to the information processing apparatus 200 to subtract, from the electronic value amount of electronic value D 210, the value amount equivalent to the added amount. When a notice, transmitted from the information processing apparatus 200, that the subtraction process is provisionally completed is received, the control section 106 transmits a command to the information processing apparatus 200 to finalize the update of the electronic value. Then, when a notice, transmitted from the information processing apparatus 200, that the update is completed is received, the control section 106 finalizes the adding of the value amount to electronic value D 136 stored in the storage section 102. Further, when any of the processes described above is not completed normally, the control section 106 can roll back the value amount of the electronic values stored in the storage section 102 and the information processing apparatus 200. Incidentally, it is needless to say that the method of transferring electronic value according to the embodiment of the present invention is not limited to the above.

Accordingly, as shown in FIG. 4B, after the write process, the value amount of electronic value D 136 is increased from “1000 P” to “1500 P” and the value amount of electronic value D 210 is decreased from “500 P” to “0 P”. That is, the sum of the value amount of electronic value D 136 stored in the storage section 102 and the value amount of electronic value D 210 stored in the IC chip 202 of the information processing apparatus 200 does not change.

Note that, FIGS. 4A and 4B show an example where the entire value amount of the electronic value D 210 stored in the IC chip 202 of the information processing apparatus 200 is transferred. However, the electronic value saving apparatus 100 according to the embodiment of the present invention is not limited to such. For example, the electronic value saving apparatus 100 can transfer arbitrary value amount based on the value amount designated by the user by operating the operating section 110. In the following, a second management method and a third management method according to the embodiment of the present invention will be described, and similar to the first management method described above, the value amount to be transferred can be arbitrary.

Further, when electronic value corresponding to the electronic value stored in the IC chip 202 of the information processing apparatus 200 is not stored in the storage section 102, the electronic value saving apparatus 100 does not need to transfer the value amount of the electronic value. At this time, the electronic value saving apparatus 100 may warn the user by using the notifying section 108 that the value amount of the electronic value cannot be transferred. Incidentally, in the above-described case, it is needless to say that the electronic value saving apparatus according to the embodiment of the present invention can newly store, in the storage section 102, the electronic value stored in the IC chip 202 of the information processing apparatus 200, for example.

As shown in FIGS. 4A and 4B, in the first management method, electronic values are stored in the storage section 102 for each service, and the respective electronic values are stored independently.

(II) Second Management Method

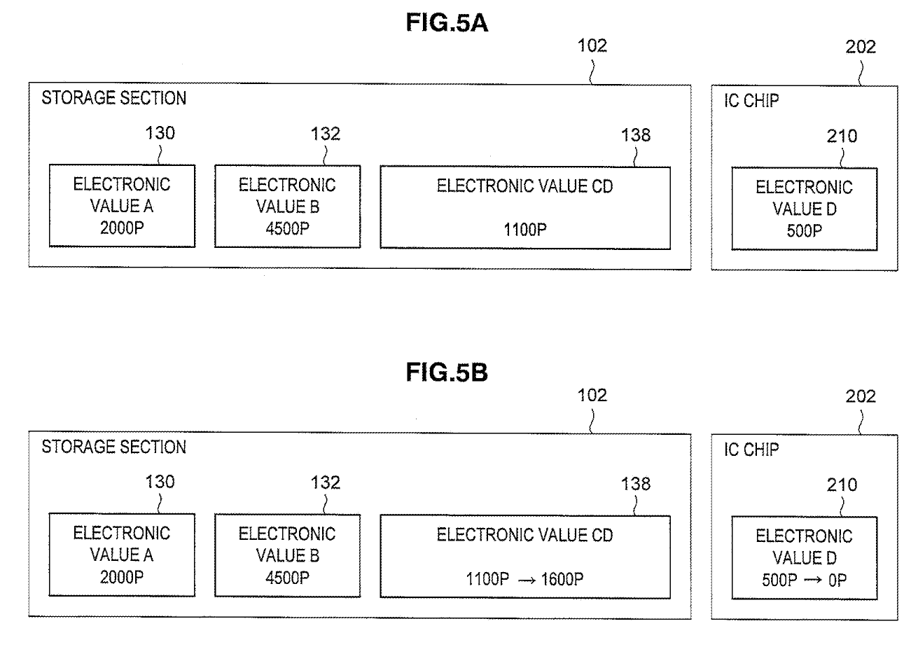

FIGS. 5A and 5B are explanatory diagrams showing the second method of managing electronic value by the electronic value saving apparatus 100 according to the embodiment of the present invention. Here, FIG. 5A shows a state before the electronic value stored in the information processing apparatus 200 is written in the storage section 102, and FIG. 5B shows a state after the electronic value stored in the information processing apparatus 200 is written in the storage section 102.

Referring to FIG. 5A, electronic value A 130 corresponding to service A, electronic value B 132 corresponding to service B, and electronic value CD 138 corresponding to service C and service D are stored in the storage section 102. Further, electronic value D 210 corresponding to service D is stored in the IC chip 202 of the information processing apparatus 200. Here, service C and service D are related services capable of using the same electronic value, such as services using electronic money issued by the same issuer or services capable of using each other's points, for example.

The control section 106 reads out electronic value D 210 stored in the information processing apparatus 200 and judges whether there is electronic value of a service corresponding to the electronic value that is read out in the storage section 102. In FIG. 5A, since electronic value CD 138 corresponding to service D is stored in the storage section 102, the control section 106 writes the value amount of electronic value D 210 in electronic value CD 138. More specifically, the control section 106 transfers the value amount “500 P” of electronic value D 210 to electronic value CD 138 in the same manner as the first management method.

Accordingly, as shown in FIG. 5B, after the write process, the value amount of electronic value CD 138 is increased from “1100 P” to “1600 P” and the value amount of electronic value D 210 is decreased from “500 P” to “0 P”.

As shown in FIGS. 5A and 5B, in the second management method, electronic values are basically stored in the storage section 102 for each service, but electronic values for related services are stored as one electronic value. Further, the value amounts of the electronic values are stored independently for each of the stored electronic values.

Incidentally, in the above, as the second management method, a method is shown where the electronic values of related services capable of using the same electronic value are stored as one electronic value. However, the second management method is not limited to such. For example, in the second management method, electronic values are exclusively available for each service, but electronic values that can be changed to another electronic value relating to another service can be managed as one electronic value (for example, an electronic value is changed to another electronic value and is stored as the other electronic value).

(III) Third Management Method

The first and the second management methods as described above indicate that electronic values are managed for each service. However, the electronic value saving apparatus according to the embodiment of the present invention is not limited to manage the electronic value for each service, and the electronic value can also be managed for each type of electronic value. Thus, next, as a third management method according to the embodiment of the present invention, a method of managing electronic money, among the electronic values, for each currency is shown.

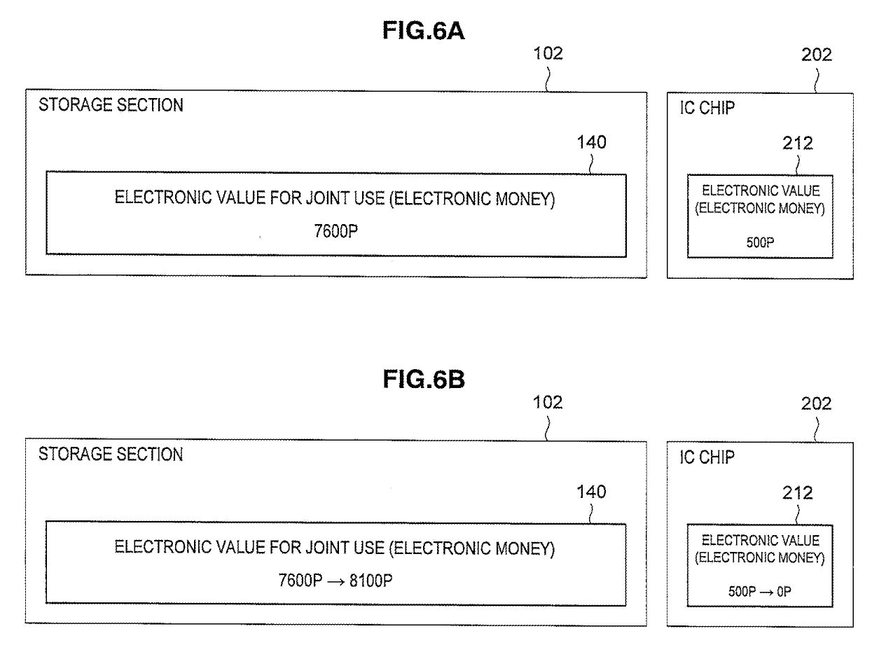

FIGS. 6A and 6B are explanatory diagrams showing the third method of managing electronic value by the electronic value saving apparatus 100 according to the embodiment of the present invention. Here, FIG. 6A shows a state before the electronic value stored in the information processing apparatus 200 is written in the storage section 102, and FIG. 6B shows a state after the electronic value stored in the information processing apparatus 200 is written in the storage section 102.

Referring to FIG. 6A, electronic value for joint use 140 indicating the electronic money of a predetermined currency is stored in the storage section 102, and electronic value 212 indicating the electronic money of the predetermined currency is stored in the IC chip 202 of the information processing apparatus 200. Here, the predetermined currency of the electronic money may be, for example, nonofficial money issued by a company providing a service. However, it may also be official money issued by a country and whose value is guaranteed by the country.

The control section 106 reads out electronic value 212 stored in the information processing apparatus 200 and judges whether there is an electronic value corresponding to the electronic value that is read out in the storage section 102. In FIG. 6A, since the electronic value for joint use 140 corresponding to the electronic value 212 is stored in the storage section 102, the control section 106 writes the value amount of the electronic value 212 in the electronic value for joint use 140. More specifically, the control section 106 transfers the value amount “500 P” of the electronic value 212 to the electronic value for joint use 140 in the same manner as with the first management method.

Accordingly, as shown in FIG. 6B, after the write process, the value amount of the electronic value for joint use 140 is increased from “7600 P” to “8100 P” and the value amount of the electronic value 212 stored in the IC chip 202 of the information processing apparatus 200 is decreased from “500 P” to “0 P”.

As shown in FIGS. 6A and 6B, in the third management method, electronic money, among the electronic values, is managed for each currency, and the value amount of electronic money of a predetermined currency is stored as one value amount of electronic value. Note that FIGS. 6A and 6B show a case where one electronic value for joint use 140 is stored in the storage section 102. However, it is needless to say that the electronic value saving apparatus according to the embodiment of the present invention can have the storage section 102 store each of multiple electronic values for joint use (that is, multiple electronic moneys for different currencies).

By using the methods shown in (I) to (III) described above, for example, the electronic value saving apparatus 100 can manage the electronic values in an integrated manner. Incidentally, in the above, the description is made with electronic value whose value amount is expressed numerically (expressed quantitatively). However, it is also possible to manage electronic value such as an electronic ticket whose value amount is not simply expressed in numerals. Here, the electronic value saving apparatus 100 can manage electronic ticket and the like for each service as shown in (I) described above, for example, but it is not limited to such.

Further, the electronic value saving apparatus 100 can store electronic value for each user for whom the user information is set in the storage section 102, and the control section 106 can apply the methods shown in (I) to (III) described above to the electronic value for the user identified by the user identifying section 114. Accordingly, the users can use the electronic value saving apparatus according to the embodiment of the present invention, which is physically one body, as if it is multiple savings boxes.

Referring again to FIG. 2, each component of the electronic value saving apparatus 100 will be described. The electronic value managing section 122 controls the method for managing the electronic value in the electronic value saving apparatus 100. More specifically, the electronic value managing section 122 determines which of the first to third management methods indicated in the above (I) to (III) is to be used, and, for example, specifies the method of transferring the value amount of the electronic value for the data processing section 120.

The goal achievement judging section 124 judges whether the goal value for electronic value set as the goal data or the goal deadline specifying the deadline for achieving the goal is met based on the goal data, the electronic value, the time information indicating date and time, and the like stored in the storage section 102. Here, the goal achievement judging section 124 can perform the judgment for each user identified by the user identifying section 114.

Further, the goal achievement judging section 124 can notify the user of the judgment result via the notifying section 108.

The state setting section 126 newly creates the state information and stores the same in the storage section 102, and further, updates the contents of the state information stored in the storage section 102 (hereinafter, creating of new state information or updating of the state information will be collectively referred to as “setting of the state information”). Here, the state setting section 126 sets the state information based on the judgment result of the goal achievement judging section 124, for example. For example, when the goal achievement judging section 124 judges that the goal is not achieved, the state setting section 126 sets the state information to a state where it is not possible to execute a process. Further, when the goal achievement judging section 124 judges that the goal is achieved, the state setting section 126 sets the state information to where it is possible to execute a process. Accordingly, if state information for a withdrawal process is set in the storage section 102, the withdrawal process becomes possible when the goal is achieved (basic process).

Further, even if the goal achievement judging section 124 judges that the goal is not achieved, the state setting section 126 can set, in accordance with a predetermined user operation, the state information stored in the storage section 102 to where it is possible to execute a process. Here, the predetermined user operation may be inputting of a password by using the operation section 110, action such as banging on the electronic value saving apparatus 100 or tilting the electronic value saving apparatus 100, or inputting of a predetermined word by using the microphone (audio input/output device 168 in FIG. 3), but it is not limited to such. The above action such as banging on the electronic value saving apparatus 100 or tilting the electronic value saving apparatus 100 can be detected by the state setting section 126 (control section 106) based on a detection result of the tilt sensor 174 or the acceleration sensor 176.

The control section 106 includes the user identifying section 114, the process type judging section 116, the state judging section 118, the data processing section 120, the electronic value managing section 122, the goal achievement judging section 124 and the state setting section 126 as described above. Accordingly, the control section 106 can execute a process after judging whether the process to be executed is a process whose execution is allowed, and also, control the execution of process based on whether the set goal is achieved or not (basic process).

The notifying section 108 is configured by, for example, the display device 166 or the audio input/output device 168, and visually or aurally conveys information to the user, for example. Further, the notifying section 108 can notify the user of the information of (i) to (iii) described below in accordance with the judgment result of the goal achievement judging section 124. Note that the information to be notified by the notifying section 108 is not limited to (i) to (iii) described below, and the notifying section 108 can also notify the savings amount (value amount of the accumulated electronic value) as shown in FIG. 1, for example. Further, the information in accordance with the judgment result of the goal achievement judging section 124 to be notified by the notifying section 108 may be information relating to the ultimate goal or it may be, for example, information relating to short-term goal for every day in the course of achieving the ultimate goal.

(i) Information that the electronic value stored in the storage section 102 reached the set goal

(ii) Information that gap between the value amount of the electronic value stored in the storage section 102 and the goal value of the set goal is within a predetermined range (goal may be reached shortly)

(iii) Comparative information of the electronic value stored in the storage section 102 to the goal value (for example, information on shortfall amount to the goal or information on the goal deadline as shown in FIG. 1)

As shown by (i) to (iii) described above, the electronic value saving apparatus 100 can present to the user information regarding the accumulation state of the electronic value in relation to the goal (ultimate goal/goals set in the course of achieving the ultimate goal) set by the user. Accordingly, the user can grasp the accumulation state of the electronic value accumulated in the electronic value saving apparatus 100, and further, the electronic value saving apparatus 100 can give the user the joy of accumulating electronic value. Note that the means of the notifying section 108 for notifying a user of information is not limited to be visual or aural, and it may be a means that appeals to the sense of smell, touch or the like of the user.

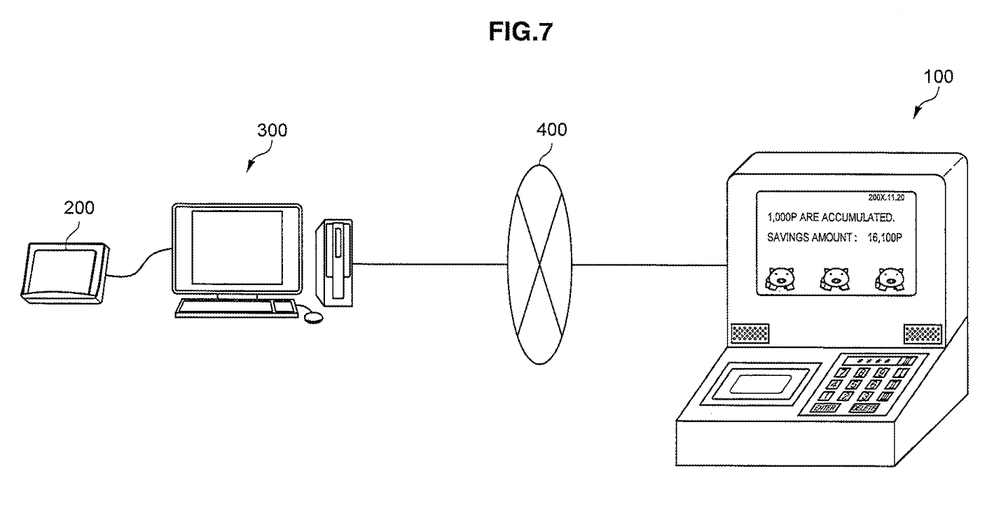

The second communicating section 112 is another communicating means included in the electronic value saving apparatus 100 for communicating with an external apparatus. Here, an example of communication between the electronic value saving apparatus 100 and the external apparatus will be shown. FIG. 7 is an explanatory diagram showing the example of the communication between the electronic value saving apparatus 100 and the external apparatus. FIG. 7 shows an example where the electronic value saving apparatus 100 and a computer 300 (external apparatus) communicate with each other via a network 400.

By using the computer 300 connected to the electronic value saving apparatus 100 via the network 400, a user possessing the information processing apparatus 200 can accumulate electronic value in the electronic value saving apparatus 100 through the procedures (1) to (4) shown below. Here, FIG. 7 shows an example where electronic value is transferred to the electronic value saving apparatus 100 from the information processing apparatus 200 and value amount of “1000 P” is accumulated in the electronic value saving apparatus 100.

(1) The computer 300 transmits a communication request, starts communication with the electronic value saving apparatus 100, and notifies the electronic value saving apparatus 100 that accumulation process is to be started

(2) In response to a reply from the electronic value saving apparatus 100, the information processing apparatus 200 is held over a reader/writer 350 connected to the computer 300

(3) Communication is performed between the electronic value saving apparatus 100 and the information processing apparatus 200 via the network 400 (and the computer 300), and the accumulation process is executed

(4) The result of the process is displayed on the electronic value saving apparatus 100 and/or the computer 300 or the information processing apparatus 200

As shown in FIG. 7, the electronic value saving apparatus 100 can execute the accumulation process via the network 400 by including the second communicating section 112. Note that, although not shown in FIG. 7, the electronic value saving apparatus 100 can execute a withdrawal process via the network 400 as in the same manner with the accumulation process.

Further, by including the second communicating section 112, the electronic value saving apparatus 100 can communicate with a server managing the electronic value (for example, a server possessed by a company issuing the electronic value). Accordingly, by cooperating with the server managing the electronic value, the electronic value saving apparatus 100 (control section 106) can also perform the exchange of the value amount of the electronic value (for example, electronic value whose value amount is exchangeable with that of another electronic value) stored in the storage section 102.

Note that processes that the electronic value saving apparatus 100 can execute by including the second communicating section 112 and cooperating with the external apparatus are not limited to the above. For example, with the electronic value saving apparatus 100 communicating, via the network 400, with a management server managing one or more electronic value saving apparatuses, it is also possible to have the management server execute the process to be executed by the electronic value saving apparatus 100.

Here, the process to be executed by the management server may be, for example, authentication of a user using the electronic value saving apparatus 100, management (integrated management) of the electronic values accumulated in the electronic value saving apparatus 100, but it is not limited to such. For example, the electronic value saving apparatus 100 can transmit the electronic value itself accumulated in the electronic value saving apparatus 100 to the management server, and the management server can store the electronic value and manage the electronic value stored in the management server. In such case, when a user withdraws the electronic value, the electronic value stored in the management server is withdrawn via the electronic value saving apparatus 100. Further, the electronic value saving apparatus 100 and the management server can encrypt the communication by using an encryption key.

Further, by the electronic value saving apparatus 100 communicating with the management server, the management server can manage the electronic value saving apparatus 100. For example, before executing various processes such as accumulation process and withdrawal process, the electronic value saving apparatus 100 requests the management server for authentication of the execution of the process, and the management server checks for negativity of each request by using a list including a unique ID and information indicating whether the electronic value saving apparatus can be used or not for each of the electronic value saving apparatuses being managed. Then, the execution of processes by the electronic value saving apparatus 100 is restricted based on the authentication result by the management server. That is, an electronic value saving apparatus whose use is not allowed as a result of the authentication by the management server cannot execute a process. Accordingly, for example, by the management server managing the electronic value saving apparatus as described above, the management server can exclude an unauthorized electronic value saving apparatus (for example, an electronic value saving apparatus tampered by a malicious third party) and prevent an unauthorized use of an electronic value saving apparatus.

Further, with the electronic value saving apparatus 100 communicating with the management server, the electronic value saving apparatus 100 can obtain a program relating to security, various programs such as control application from the management server via the network 400. Accordingly, the electronic value saving apparatus 100 can operate in a more secure condition, and thus, the unauthorized use of the electronic value saving apparatus 100 can be more securely prevented.

As described above, with the configuration as shown in FIG. 2, the electronic value saving apparatus 100 according to the embodiment of the present invention can manage in an integrated manner the electronic values stored in the information processing apparatus 200 by using the management methods shown in FIGS. 4 to 6, for example, and accumulate electronic value.

Further, the electronic value saving apparatus 100 judges the types of processes defining the transmission/reception of electronic value such as accumulation process and withdrawal process, judges whether execution of process for each type of process is possible or not, and in case the execution is possible, executes the process. Here, the electronic value saving apparatus 100 can judge whether execution of process for each type of process is possible based on the state information specifying whether execution of process for each type of process is possible or not, and further, with regard to a process for which the state information is not set, the electronic value saving apparatus 100 can treat the process as a process whose execution is possible. For example, in case the state information is set only for the withdrawal process, the electronic value saving apparatus 100 arbitrarily executes the accumulation process, and the withdrawal process is restricted according to the state information. Accordingly, since the electronic value saving apparatus 100 can restrict the execution of a specific process (for example, withdrawal process) based on the stored state information, a function similar to that of a savings box accumulating physical money, where electronic value is easy to put away but is difficult to draw out, can be realized.

Further, the electronic value saving apparatus 100 can present, to a user, information relating to the accumulation state of the electronic value in relation to the goal set by the user in a way that appeals to the user visually or aurally. Accordingly, the user can grasp the accumulation state of the electronic value accumulated in the electronic value saving apparatus 100, and further, the electronic value saving apparatus 100 can give the user the joy of accumulating electronic value.

The explanation has been made with the electronic value saving apparatus 100 as an example of the embodiment of the present invention. However, the embodiment of the present invention is not limited to such mode. For example, the embodiment of the present invention can be applied to a computer such as a personal computer (PC), a reader/writer in a store, or an arbitrary apparatus with which accumulation or withdrawal of electronic value is enabled.

Further, in the above, as the embodiment of the present invention, an apparatus serving as a savings box for electronic value has been described as an example. However, the embodiment of the present invention is not limited to such mode. For example, the electronic value saving apparatus according to the embodiment of the present invention can be applied to an electronic donation apparatus serving as a donation box for electronic value.

### Program According to the Embodiment of the Present Invention

With a program that makes a computer function as the electronic value saving apparatus 100 according to the embodiment of the present invention, electronic values stored in an information processing apparatus capable of storing the electronic values can be managed in an integrated manner, and the electronic values can be accumulated.

(Electronic Value Processing Method)

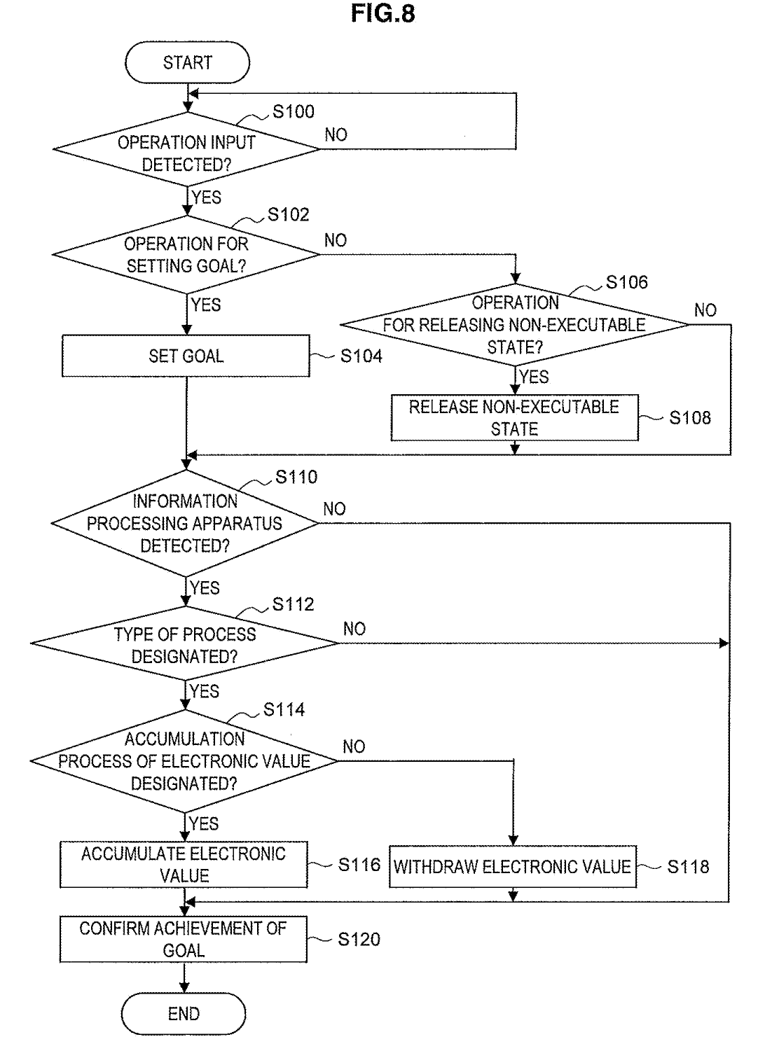

Next, a method of processing electronic value by the electronic value saving apparatus according to the embodiment of the present invention will be described. Note that, in the following, along with the method of processing electronic value according to the embodiment of the present invention, various processes by the electronic value saving apparatus 100 described above, such as process of setting a goal or confirming the achievement of the goal will be described. FIG. 8 is a flow chart showing an example of the method of processing electronic value according to the embodiment of the present invention. Here, each process shown in FIG. 8 can be executed by the control section 106 of the electronic value saving apparatus 100.

The electronic value saving apparatus judges whether an operation input is detected or not (S100). The electronic value saving apparatus 100 can detect an operation input based on, for example, an input signal from the operation section 110, the detection results of the tilt sensor 174 and the acceleration sensor 176, or the detection of a communication request from an external apparatus received by the second communicating section 112. Here, in case an operation input is not detected in step S100, the electronic value saving apparatus 100 does not proceed with the process.

Further, when an operation input is detected in step S100, the electronic value saving apparatus 100 judges whether the detected operation input is for setting a goal or not (S102). When it is judged in step S102 that the operation input detected is for setting a goal, the electronic value saving apparatus 100 executes the process of setting a goal (S104).

[Goal Setting Process]

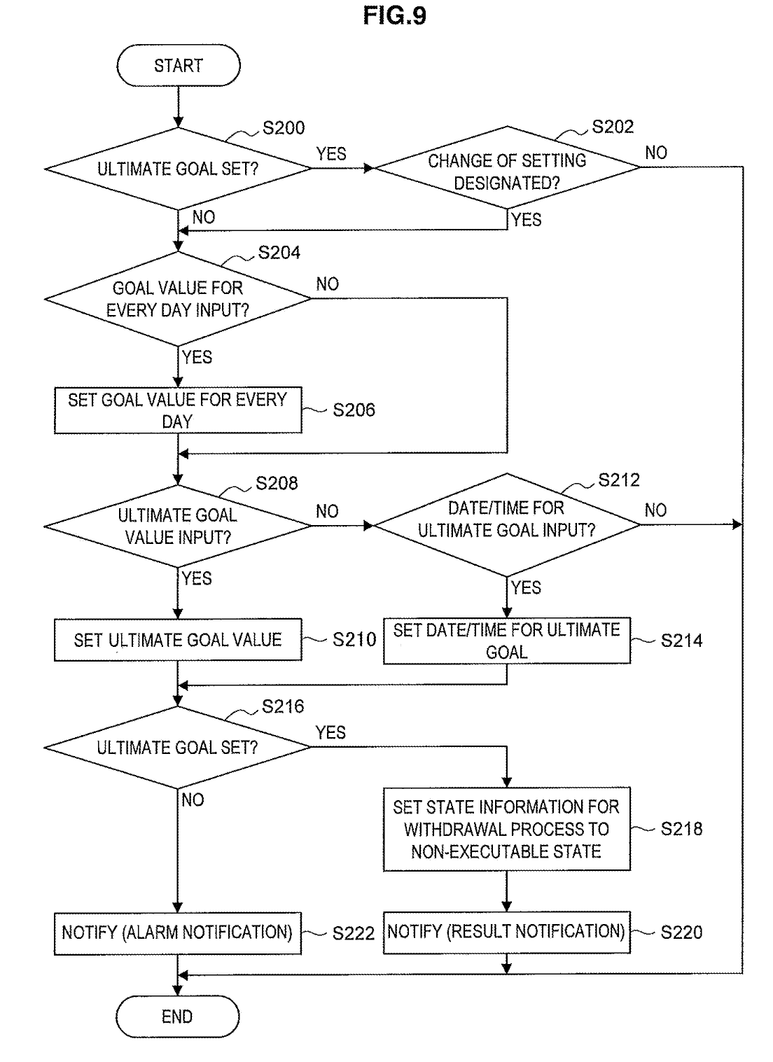

FIG. 9 is a flow chart showing an example of the process of setting a goal according to the embodiment of the present invention. The electronic value saving apparatus 100 can execute the process of setting a goal shown in FIG. 9 based on the operation input detected in step S100 of FIG. 8.

The electronic value saving apparatus 100 judges whether an ultimate goal (for example, value amount to be the ultimate goal for accumulation and deadline for achieving the goal) for electronic value is set or not (S200).

[1] When Ultimate Goal for Electronic Value is Already Set

When it is judged in step S200 that an ultimate goal for the electronic value is already set, the electronic value saving apparatus 100 judges whether the change of the setting is designated or not (S202). When it is judged in step S202 that the change of the setting is not designated, the electronic value saving apparatus 100 terminates the process of setting a goal.

Further, when it is judged in step S202 that the change of the setting is designated, the electronic value saving apparatus 100 judges whether goal value for every day (value amount to be a goal set in the course of achieving the ultimate goal) is input or not (S204).

When it is judged in step S204 that goal value for every day is input, the electronic value saving apparatus 100 sets the goal value for every day as the goal data and proceeds with the process (S206), and when it is not judged that goal value for every day are input, the electronic value saving apparatus 100 proceeds with the process.

The electronic value saving apparatus 100 judges whether an ultimate goal value (value amount to be the ultimate goal for accumulation) is input or not (S208). When it is judged in step S208 that an ultimate goal value is input, the electronic value saving apparatus 100 sets the ultimate goal value as the goal data (S210).

Further, when it is not judged in step S208 that an ultimate goal value is input, the electronic value saving apparatus 100 judges whether date/time for the ultimate goal (deadline for achieving the goal) is input or not (S212).

When it is judged in step S212 that date/time for the ultimate goal is input, the electronic value saving apparatus 100 sets the date/time for the ultimate goal as the goal data (S214). Further, when it is not judged in step S212 that date/time for the ultimate goal is input, the electronic value saving apparatus 100 terminates the process of setting a goal.

After the process of step S210 or step S214 is executed, the electronic value saving apparatus 100 judges whether an ultimate goal is set (S216). Here, the judgment of step S216 can be performed based on whether both of the ultimate goal value and the date/time for the ultimate goal are set or not.

When it is judged in step S216 that an ultimate goal is set, the electronic value saving apparatus 100 sets the state information for the withdrawal process to a non-executable state (S218), and notifies the user of the same (S220; result notification). With the state information for the withdrawal process set to the non-executable state in step S218, the withdrawal process can be restricted until the goal is achieved. In the following, a description will be made assuming that the state information for the withdrawal process is set in the storage section 102 of the electronic value saving apparatus 100.

Further, when it is not judged in step S216 that an ultimate goal is set, the electronic value saving apparatus 100 notifies the user of the same (S222; alarm notification). [2] When Ultimate Goal for Electronic Value is not Set

When it is not judged in step S200 that an ultimate goal for the electronic value is set, the electronic value saving apparatus 100 judges whether goal value for every day is input or not (S204). Then, the electronic value saving apparatus 100 executes the processes of steps S206 to S220 as in the same manner as in the case described above where an ultimate goal for the electronic value is already set.

The electronic value saving apparatus 100 can execute the process of setting a goal by using the method as shown in FIG. 9, for example.

Referring again to FIG. 8, the method of processing electronic value according to the embodiment of the present invention will be described. When it is not judged in step S102 that the detected operation input is for setting a goal, the electronic value saving apparatus 100 judges whether the operation input is for releasing a non-executable state or not (S106).

When it is judged in step S106 that the operation input is for releasing a non-executable state, the electronic value saving apparatus 100 executes the process of releasing the non-executable state (S108), and when it is not judged in step S106 that the operation input is for releasing the non-executable state, the electronic value saving apparatus 100 proceeds with the process.

[Non-Executable State Releasing Process]

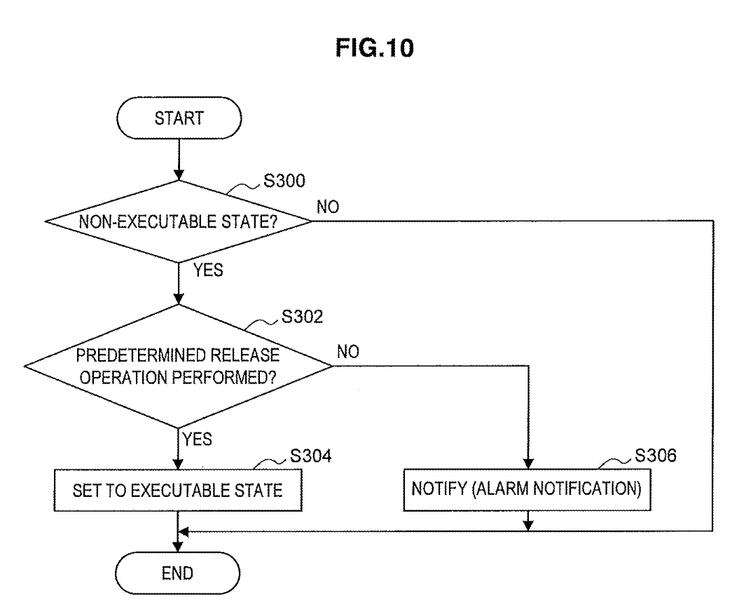

FIG. 10 is a flow chart showing an example of the process of releasing a non-executable state according to the embodiment of the present invention.

The electronic value saving apparatus 100 judges whether the state information (for a withdrawal process) is set to the non-executable state or not (S300). When it is not judged in step S300 that the state information is set to the non-executable state, the electronic value saving apparatus 100 terminates the process of releasing the non-executable state.

Further, when it is judged in step S300 that the state information is set to the non-executable state, the electronic value saving apparatus 100 judges whether a predetermined release operation is performed or not (S302). Here, the predetermined release operation described above may be, for example, inputting of a password, banging on the electronic value saving apparatus 100 or inputting of a predetermined word using voice. The electronic value saving apparatus 100 can perform the judgment of step S302 by using, for example, an input signal from the operation section 110, the detection results of the tilt sensor 174 and the acceleration sensor 176, or the detection result of the audio input/output device 168.

When it is judged in step S302 that the predetermined release operation is performed, the electronic value saving apparatus 100 sets the state information to an executable state (S304). With the state information set to the executable state in step S304, the electronic value saving apparatus 100 can execute the process (withdrawal process) corresponding to the state information (exceptional process). Accordingly, even if the set goal is not achieved, the user can withdraw the electronic value stored in the electronic value saving apparatus 100 by performing the predetermined release operation.

Further, when it is not judged in step S302 that the predetermined release operation is performed, the electronic value saving apparatus 100 notifies the user of the same (S306; alarm notification).

The electronic value saving apparatus 100 can execute the process of releasing a non-executable state by using the method as shown in FIG. 10, for example.

Referring again to FIG. 8, the method of processing electronic value according to the embodiment of the present invention will be described. The electronic value saving apparatus 100 judges whether the information processing apparatus 200 is detected or not (S110). The electronic value saving apparatus 100 can execute the process of step S110 by performing polling by using the first communicating section 104.

When it is not judged in step S110 that the information processing apparatus 200 is detected, the electronic value saving apparatus 100 executes the process of confirming the achievement of a goal of step S120 described later.

Further, when it is judged in step S110 that the information processing apparatus 200 is detected, the electronic value saving apparatus 100 judges whether a type of process defining the transmission/reception of electronic value is designated or not (S112). Here, the type of process may be the accumulation process relating to the reception of electronic value or the withdrawal process relating to the transmission of electronic value.

When it is not judged in step S112 that a type of process defining the transmission/reception of electronic value is designated, the electronic value saving apparatus 100 executes the process of confirming the achievement of a goal of step S120 described later.

Further, when it is judged in step S112 that a type of process defining the transmission/reception of electronic value is designated, the electronic value saving apparatus 100 judges whether the accumulation process of the electronic value is designated or not (S114).

When it is judged in step S114 that the accumulation process of the electronic value is designated, the electronic value saving apparatus 100 executes the accumulation process of the electronic value (S116). Further, when it is not judged in step S114 that the accumulation process of the electronic value is designated, the electronic value saving apparatus 100 executes the withdrawal process of the electronic value (S118).

Then, when the accumulation process of the electronic value of step S116 or the withdrawal process of the electronic value of step S118 is executed, the electronic value saving apparatus 100 executes the process of confirming the achievement of a goal (S120).

[Electronic Value Accumulation Process]

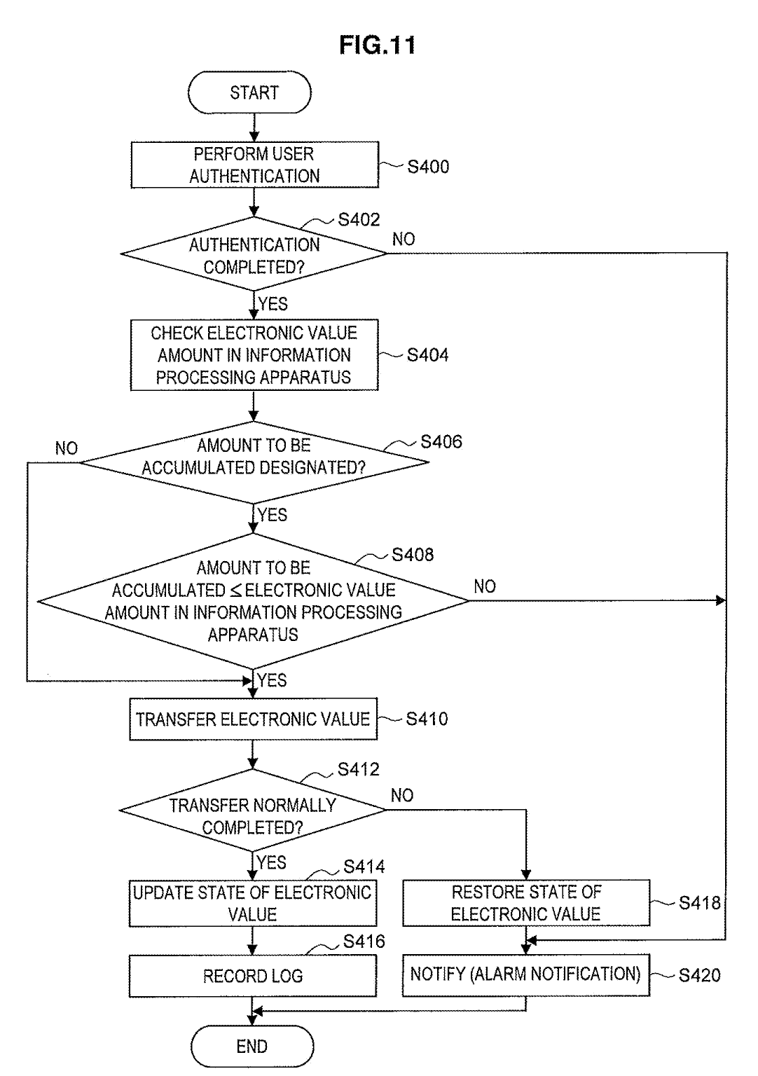

FIG. 11 is a flow chart showing an example of the accumulation process of electronic value of the embodiment of the present invention.

The electronic value saving apparatus 100 performs user authentication (S400), and judges whether the authentication is completed or not (S402). The electronic value saving apparatus executes the processes of steps S400 and S402 by using an input signal from the operation section 110 and the user information stored in the storage section 102, for example.

When it is not judged in step S402 that the authentication is completed, the electronic value saving apparatus 100 notifies the user of the same (S420; alarm notification).

Further, when it is judged in step S402 that the authentication is completed, the electronic value saving apparatus 100 checks the value amount of the electronic value stored in the information processing apparatus 200 (S404).

The electronic value saving apparatus 100 judges whether the amount to be accumulated (the value amount to be transferred from the information processing apparatus 200 to the electronic value saving apparatus 100) is designated or not (S406). Here, the electronic value saving apparatus 100 can perform the judgment of step S406 based on, for example, an input signal from the operation section 110 or accumulation set data (for example, stored in the storage section 102; not shown) where the amount to be accumulated is pre-set.

When the amount to be accumulated is not designated in step S406, the electronic value saving apparatus 100 transfers all of the electronic values stored in the information processing apparatus 200 (S410; full-amount transfer).

Further, when the amount to be accumulated is designated in step S406, the electronic value saving apparatus 100 judges whether the condition “amount to be accumulated≦value amount of electronic value stored in information processing apparatus 200” is met or not (S408).

When it is judged in step S408 that the condition is met, the electronic value saving apparatus 100 transfers the amount equivalent to the designated amount to be accumulated from the electronic value stored in the information processing apparatus 200 (S410; partial transfer).

Further, when it is not judged in step S408 that the condition is met, the electronic value saving apparatus 100 notifies the user of the same (S420; alarm notification). Incidentally, FIG. 11 shows a process where the electronic value is not transferred when it is not judged that the condition is met. However, the accumulation process of the electronic value according to the embodiment of the present invention is not limited to such. For example, the accumulation process of electronic value according to the embodiment of the present invention can transfer all of the electronic values stored in the information processing apparatus 200 when it is not judged that the condition is met.

After the electronic value is transferred in step S410, the electronic value saving apparatus 100 judges whether the transfer of the electronic value is completed or not (S412). Here, the electronic value saving apparatus 100 can judge that the transfer of the electronic value is completed when the amount equivalent to the amount added to the storage section 102 is subtracted from the value amount of the electronic value of the information processing apparatus 200.

When it is judged in step S412 that the transfer of the electronic value is completed, the electronic value saving apparatus 100 has the states of the electronic value stored in the storage section 102 and the electronic value stored in the information processing apparatus 200 updated (S414), and records a log (S416).

Further, when it is not judged in step S412 that the transfer of the electronic value is completed, the electronic value saving apparatus 100 restores (rolls back) the states of the electronic value stored in the storage section 102 and the electronic value stored in the information processing apparatus 200 to the states before the transfer (S418), and notifies the user of the same (S420; alarm notification). Incidentally, although not shown in FIG. 11, the electronic value saving apparatus according to the embodiment of the present invention can record a log when it is not judged in step S412 that the transfer of the electronic value is completed.

The electronic value saving apparatus 100 can execute the accumulation process of electronic value by using the method as shown in FIG. 11, for example.

[Electronic Value Withdrawal Process]

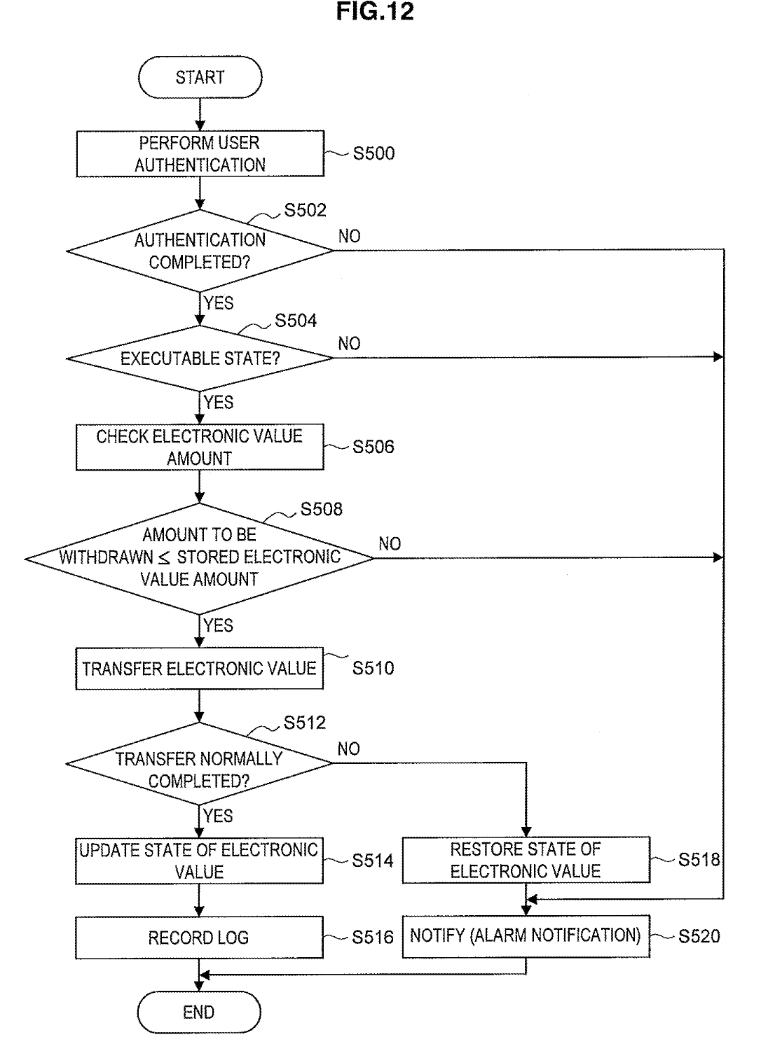

FIG. 12 is a flow chart showing an example of the withdrawal process of electronic value according to the embodiment of the present invention.

The electronic value saving apparatus 100 performs the user authentication (S500) and judges whether the authentication is completed or not (S502) as in the same manner as in steps S400 and S402 of FIG. 11. When it is not judged in step S502 that the authentication is completed, the electronic value saving apparatus 100 notifies the user of the same (S520; alarm notification).

Further, when it is judged in step S502 that the authentication is completed, the electronic value saving apparatus 100 judges whether execution of the withdrawal process is possible or not (S504). The electronic value saving apparatus 100 can perform the judgment of step S504 based on the state information (for the withdrawal process).

When it is not judged in step S504 that it is possible to execute the withdrawal process, the electronic value saving apparatus 100 notifies the user of the same (S520; alarm notification).

Further, when it is judged in step S504 that the execution of the withdrawal process is possible, the electronic value saving apparatus 100 checks the value amount of the electronic value stored in the storage section 102 (S506). Then, the electronic value saving apparatus 100 judges whether the condition “amount to be withdrawn≦value amount of electronic value stored in storage section 102” is met or not (S508). The electronic value saving apparatus 100 can determine the amount to be withdrawn based on, for example, an input signal from the operation section 110 or withdrawal set data (for example, stored in the storage section 102; not shown) where the amount to be withdrawn is pre-set.

Here, when the withdrawal set data is stored in the storage section 102, even if, for example, value amount more than the amount set by the withdrawal set data to be withdrawn is stored in the storage section 102, only the amount to be withdrawn is withdrawn at a time. Accordingly, the electronic value saving apparatus according to the embodiment of the present invention can be used, for example, by parents for giving children allowances. Further, the electronic value saving apparatus according to the embodiment of the present invention can prevent the excessive spending of the electronic value.

When it is not judged in step S508 that the condition is met, the electronic value saving apparatus 100 notifies the user of the same (S520; alarm notification).

Further, when it is judged in step S508 that the condition is met, the electronic value saving apparatus 100 transfers the electronic value stored in the storage section 102 to the information processing apparatus 200 (S510).

After the electronic value is transferred in step S510, the electronic value saving apparatus 100 judges whether the transfer of the electronic value is completed or not (S512). Here, the electronic value saving apparatus 100 can judge that the transfer of the electronic value is completed when the amount equivalent to the amount added to the information processing apparatus 200 is subtracted from the value amount of the electronic value of the storage section 102.

When it is judged in step S512 that the transfer of the electronic value is completed, the electronic value saving apparatus 100 updates the states of the electronic value stored in the storage section 102 and the electronic value stored in the information processing apparatus 200 (S514), and records a log (S516).

Further, when it is not judged in step S512 that the transfer of the electronic value is completed, the electronic value saving apparatus 100 restores (rolls back) the states of the electronic value stored in the storage section 102 and the electronic value stored in the information processing apparatus 200 to the states before the transfer (S518), and notifies the user of the same (S520; alarm notification). Incidentally, although not shown in FIG. 12, the electronic value saving apparatus according to the embodiment of the present invention can record a log when it is not judged in step S512 that the transfer of the electronic value is completed.

The electronic value saving apparatus 100 can execute the withdrawal process of electronic value by using the method as shown in FIG. 12, for example.

[Goal Achievement Confirmation Process]

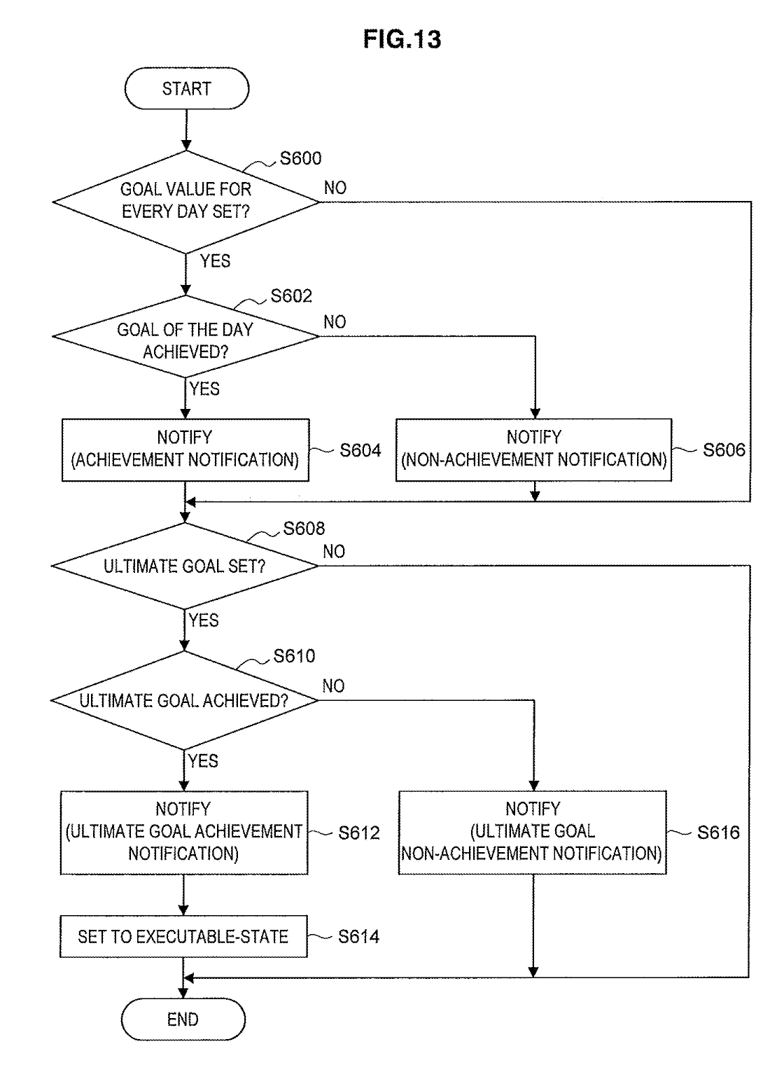

FIG. 13 is a flow chart showing an example of a process of confirming the achievement of a goal according to the embodiment of the present invention.

The electronic value saving apparatus 100 judges whether goal value for every day is set or not (S600).

When it is not judged in step S600 that goal value for every day is set, the electronic value saving apparatus 100 proceeds to the process of step S608 described later.

Further, when it is judged in step S600 that goal value for every day is set, the electronic value saving apparatus 100 judges whether the goal for the day is achieved or not (S602). The electronic value saving apparatus 100 can perform the judgment of step S602 based on, for example, goal data, time information, and a log file stored in the storage section 102.

When it is judged in step S602 that the goal for the day is achieved, the electronic value saving apparatus 100 notifies the user that the goal is achieved (S604), and further, when it is not judged in step S602 that the goal for the day is achieved, the electronic value saving apparatus 100 notifies the user that the goal is not achieved (S606).

Next, the electronic value saving apparatus 100 judges whether an ultimate goal is set or not (S608). When it is not judged in step S608 that an ultimate goal is set, the electronic value saving apparatus 100 terminates the process. Incidentally, although not shown in FIG. 13, the electronic value saving apparatus according to the embodiment of the present invention can also send an alarm notification to the user when it is not judged in step S608 that an ultimate goal is set.

Further, when it is judged in step S608 that an ultimate goal is set, the electronic value saving apparatus 100 judges whether the ultimate goal is achieved or not (S610). The electronic value saving apparatus 100 can perform the judgment of step S610 based on, for example, the electronic value stored in the storage section 102 and the goal data.

When it is judged in step S610 that the goal for the day is achieved, the electronic value saving apparatus 100 notifies the user that the ultimate goal is achieved (S612), and sets the state information for the withdrawal process to an executable state (S614). Further, when it is not judged in step S610 that the goal for the day is achieved, the electronic value saving apparatus 100 notifies the user that the ultimate goal is not achieved (S616).

The electronic value saving apparatus 100 can execute the process of confirming the achievement of a goal for the electronic value by using the method as shown in FIG. 13, for example.

The electronic value saving apparatus 100 according to the embodiment of the present invention processes electronic value by using the methods of FIGS. 8 to 13, for example. Accordingly, the electronic value saving apparatus 100 using the electronic value processing method according to the embodiment of the present invention can manage in an integrated manner the electronic values stored in the information processing apparatus capable of storing electronic value, and accumulate electronic value.

Further, since the electronic value saving apparatus 100 using the electronic value processing method according to the embodiment of the present invention can restrict execution of a specific process (for example, withdrawal process) based on state information, a function similar to that of a savings box accumulating physical money, where electronic value is easy to put away but is difficult to draw out, can be realized.

Further, the electronic value saving apparatus 100 using the electronic value processing method according to the embodiment of the present invention can present, to a user, information relating to the accumulation state of the electronic value in relation to the goal set by the user in a way that appeals to the user visually or aurally. The user can grasp the accumulation state of the electronic value accumulated in the electronic value saving apparatus 100, and further, the electronic value saving apparatus 100 can give the user the joy of accumulating electronic value.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic value saving apparatus that communicates in a contact/non-contact manner with an information processing apparatus capable of storing electronic value, comprising:
a storage section storing one or more electronic values relating to a predetermined service;
a first communicating section communicating with the information processing apparatus and transmitting/receiving the electronic value to/from the information processing apparatus;
a process type judging section judging a type of process defining the transmission/reception of the electronic value;
a state judging section judging whether execution of process is possible for each type of process based on the judgment result of the process type judging section; and
a data processing section processing the electronic value received from the information processing apparatus or the electronic value to be transmitted to the information processing apparatus based on the judgment result of the process type judging section and the judgment result of the state judging section.

2. The electronic value saving apparatus according to claim 1, wherein
the storage section further stores state information specifying whether execution of process is possible; and
the state judging section judges whether execution of process is possible based on the judgment result of the process type judging section and the state information.

3. The electronic value saving apparatus according to claim 2, wherein
the state information specifies whether execution of process of transmitting the electronic value to the information processing apparatus is possible; and
the state judging section judges, when the judgment result of the process type judging section indicates the process of transmitting the electronic value to the information processing apparatus, whether execution of process is possible in accordance with the state information, and judges, when the judgment result of the process type judging section indicates the process of receiving the electronic value from the information processing apparatus, that the process can be executed.

4. The electronic value saving apparatus according to claim 2, wherein
the storage section stores user information including setup information for user; and
the electronic value saving apparatus further comprises:
a user identifying section identifying a user based on a user operation and the user information, wherein
the state judging section judges whether execution of process is possible for each user identified by the user identifying section.

5. The electronic value saving apparatus according to claim 4, further comprising:
an electronic value managing section managing for each user based on the user information, the electronic value stored in the storage section, wherein
the data processing section processes the electronic value for the user identified by the user identifying section among the electronic values being managed for respective users in the storage section.

6. The electronic value saving apparatus according to claim 1, wherein
the storage section further stores goal data including goal value for the electronic value to be stored or goal data including the goal value and goal deadline specifying deadline for achieving the goal; and
the electronic value saving apparatus further comprises:
a goal achievement judging section judging whether the goal is achieved or not based on the goal data and the electronic value that is stored in the storage section.

7. The electronic value saving apparatus according to claim 6, further comprising:
a state setting section setting, in the storage section, state information specifying whether execution of process is possible based on the judgment result of the goal achievement judging section.

8. The electronic value saving apparatus according to claim 7, wherein
the state setting section sets the state information stored in the storage section to a state where execution of process is possible in response to a predetermined user operation even when the goal achievement judging section judges that the goal is not achieved.

9. The electronic value saving apparatus according to claim 6, further comprising:
a notifying section notifying a user, wherein
the goal achievement judging section makes the notifying section notify the state of the electronic value stored in the storage section in relation to the goal value.

10. The electronic value saving apparatus according to claim 9, wherein
the goal achievement judging section makes the notifying section notify at least one or more of the pieces of information that the electronic value stored in the storage section reached the goal, information that gap between the electronic value stored in the storage section and the goal value is within a predetermined range and comparative information of the electronic value stored in the storage section to the goal value.

11. The electronic value saving apparatus according to claim 6, further comprising:
an operation section setting the goal value and/or the goal deadline in the goal data.

12. The electronic value saving apparatus according to claim 1, wherein
the data processing section adds the electronic value transmitted from the information processing apparatus to the electronic value that corresponds to the electronic value transmitted from the information processing apparatus among the electronic values stored in the storage section, and has a command to subtract the amount that corresponds to the added amount from the electronic value stored in the information processing apparatus transmitted to the information processing apparatus.

13. The electronic value saving apparatus according to claim 1, wherein
the data processing section subtracts from the electronic value that corresponds to the electronic value transmitted to the information processing apparatus, among the electronic values stored in the storage section, the amount corresponding to the amount transmitted to the information processing apparatus.

14. The electronic value saving apparatus according to claim 1, wherein
the data processing section stores, in the storage section, a log corresponding to the processing on the electronic value.

15. The electronic value saving apparatus according to claim 1, further comprising:
a second communicating section communicating with an external apparatus storing the electronic value via a network, wherein
the data processing section processes the electronic value the second communicating section received.

16. An electronic value processing method of an electronic value saving apparatus that comprises a storage section storing one or more electronic values relating to a predetermined service and a communicating section, and communicates in a contact/non-contact manner with an information processing apparatus capable of storing electronic value, including the steps of:
judging a type of process defining the transmission/reception of the electronic value;
judging whether execution of process is possible for each type of process based on the judgment result of the step of judging a type of process; and
processing the electronic value received from the information processing apparatus or the electronic value to be transmitted to the information processing apparatus based on the judgment result of the step of judging a type of process and the judgment result of the step of judging whether execution of process is possible.

17. A program, which can be used in an electronic value saving apparatus that comprises a storage section storing one or more electronic values relating to a predetermined service and a communicating section, and communicates in a contact/non-contact manner with an information processing apparatus capable of storing the electronic value, making a computer perform the steps of:
judging a type of process defining the transmission/reception of the electronic value;
judging whether execution of process is possible for each type of process based on the judgment result of the step of judging a type of process; and
processing the electronic value received from the information processing apparatus or the electronic value to be transmitted to the information processing apparatus based on the judgment result of the step of judging a type of process and the judgment result of the step of judging whether execution of process is possible.
